(19) United States
(12) Patent Application Publication
(10) Pub. No.: US 2024/0005314 A1
(43) Pub. Date: Jan. 4, 2024

(54) SUPPLY MANAGEMENT SYSTEM

(71) Applicant: Dell Products L.P., Round Rock, TX (US)

(72) Inventors: Dhilip Kumar, Bangalore (IN); Ajay Maikhuri, Bangalore (IN)

(73) Assignee: Dell Products L.P., Round Rock, TX (US)

(21) Appl. No.: 17/810,110

(22) Filed: Jun. 30, 2022

(51) Int. Cl. G06Q 20/38; H04L 9/30; H04L 9/08

(52) U.S. Cl. CPC G06Q 20/389; G06Q 20/3829; H04L 9/30; H04L 9/088; G06Q 2220/00

(57) ABSTRACT

A method comprising: storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs.

### BACKGROUND

A supply chain is an entire system of producing and delivering a final product, from the sourcing of various components and sub-components to the final delivery of the product. Efficient information sharing among different suppliers in a supply chain is essential for the proper functioning of the supply chain. Specifically, efficient information sharing may help a supplier to mitigate disruptions occurring far down in the supply chain from the supplier. Such disruptions may be caused by geopolitical tensions, pandemics, or global geo-economic uncertainty.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a non-transitory computer-readable medium is provided that stores one or more processor-executable instructions which, when executed, by one or more processors cause the one or more processors to perform the operations of: storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs, wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

According to aspects of the disclosure, a method is provided comprising: one or more processors configured to perform the operations of: storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs, wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

According to aspects of the disclosure, a non-transitory computer-readable medium is provided that stores one or more processor-executable instructions which, when executed, by one or more processors cause the one or more processors to perform the operations of: storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs, wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a transaction node, according to aspects of the disclosure;

FIG. 2A is a diagram of an example of a supply chain, according to aspects of the disclosure;

FIG. 2B is a diagram of an example of a system, according to aspects of the disclosure;

FIG. 3A is a diagram of an example of a blockchain system, according to aspects of the disclosure;

FIG. 3B is a diagram of an example of a blockchain system, according to aspects of the disclosure;

FIG. 4 is a flowchart of an example of a process, according to aspects of the disclosure;

FIG. 5A is a flowchart of an example of a process, according to aspects of the disclosure;

FIG. 5B is a flowchart of an example of a process, according to aspects of the disclosure;

FIG. 6A is a flowchart of an example of a process, according to aspects of the disclosure;

FIG. 6B is a flowchart of an example of a process, according to aspects of the disclosure;

FIG. 7 is a flowchart of an example of a process, according to aspects of the disclosure; and

FIG. 8 is a diagram of an example of a computing device, according to aspects of the disclosure.

### DETAILED DESCRIPTION

According to the present disclosure, a multi-tier supply chain management system is provided. The system enables the sharing of data among suppliers from different tiers of a supply chain. The system intelligently integrates a supply-chain tier model in its operations. Specifically, the system shares various types of information with different suppliers in the supply chain based on the tier of the suppliers. Examples of information that is shared include information about a supplier that is party to a specific transaction, the capacity of a supplier to produce a part that is subject to the transaction, the cost of the part, information about the quality of the part, or information about various compliance policies that are implemented by the supplier with respect to the part. The multi-tier supply chain management system enables comprehensive end-to-end traceability of materials within a supply chain, as well as a secure sharing of transaction information between suppliers from non-consecutive tiers of the supply chain.

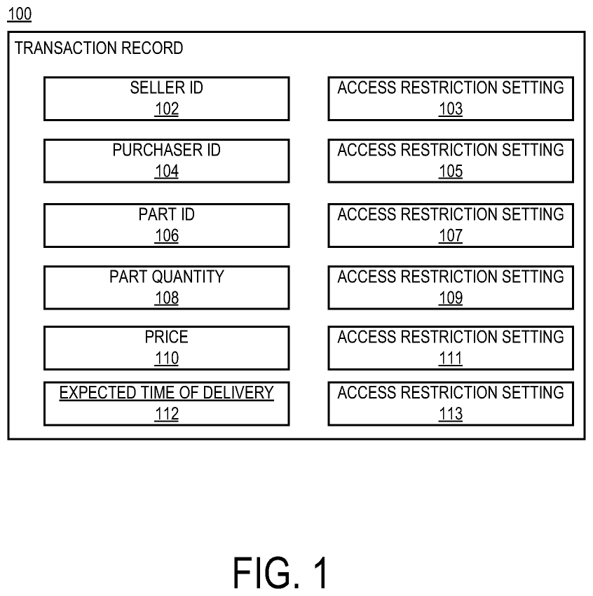

FIG. 1 is a diagram of an example of a transaction record 100, according to aspects of the disclosure. The transaction record 100 may include a data structure (or portion thereof), which is stored in the ledger of a blockchain system. The transaction record 100 may include information associated with the purchase of an item (e.g., a part) from a first supplier in a supply chain by a second supplier in the supply chain. The transaction record 100 may include an identifier 102 of the seller, an identifier 104 of the purchaser, an identifier 106 of the item that is being purchased, an identifier 108 of the quantity that is purchased, an identifier 110 of the price of the item, and an identifier 112 of an expected time of delivery. Although not shown in FIG. 1, the transaction record 100 may include additional information, such as information about policy compliance, a part datasheet, and/or any suitable type of information. The transaction record 100 may be implemented as a standalone data structure or part of a larger data structure.

The transaction record 100 may include a plurality of access restriction settings. Each access restriction setting may include a number, a string, or an alphanumerical string that specifies access permissions for a particular data item (or group of data items). Each of the access restriction settings may identify one or more of: (i) a specific supplier (or customer) that is permitted to view a given data item that is associated with the access restriction setting, (ii) a specific tier in the supply chain whose constituent suppliers are permitted to view the given data item, (iii) a specific supplier (or customer) that is not permitted to view the given data item, (iv) a specific tier in the supply chain whose constituent suppliers are not permitted to view the given data item. In other words, each of the access restriction settings may include: (i) a supplier identifier that uniquely identifies the supplier among a plurality of suppliers and/or (ii) a tier identifier that uniquely identifies a tier in the supply chain 200 among a plurality of tiers in the supply chain 200. According to the present example, access restriction setting 103 is associated with data item 102; access restriction setting 105 is associated with data item 104; access restriction setting 107 is associated with data item 106; access restriction setting 109 is associated with data item 108; access restriction setting 111 is associated with data item 110; and access restriction setting 113 is associated with data item 112. Although the access restriction settings are depicted as being integrated into the transaction record 100, alternative implementations are possible in which they are provided separately from the transaction record 100.

Although in the present example the transaction record 100 is associated with a specific transaction, alternative implementations are possible in which the transaction record is not associated with any specific transaction. Irrespective of whether the transaction record 100 is associated with a particular transaction, the transaction record may also include information that is not specific to any individual transaction, such as information about a supplier's capacity, datasheets from parts that are provided by the supplier, information about the compliance of the manufacturer with various standards and policies.

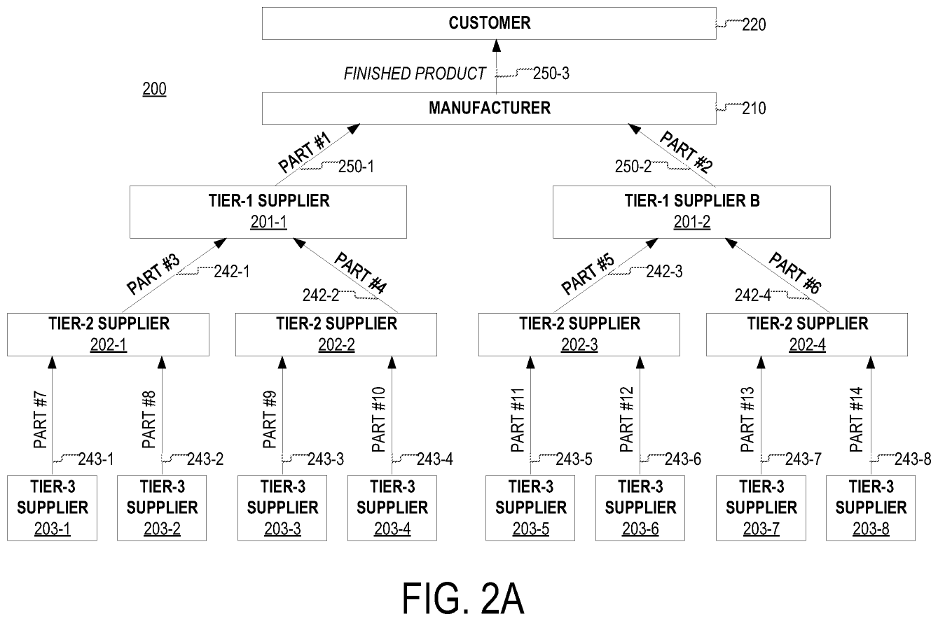

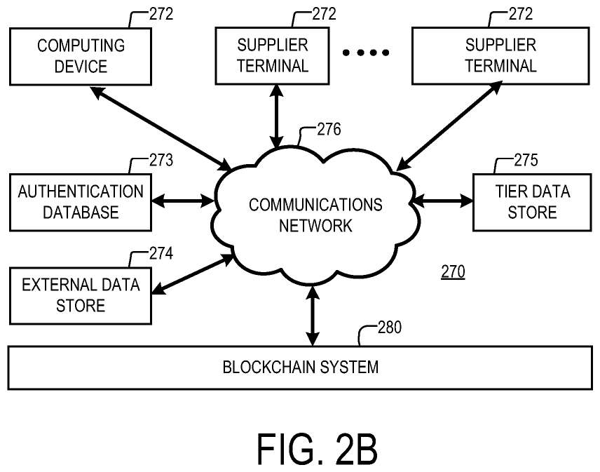

FIG. 2A is a diagram of an example of a supply chain 200, according to aspects of the disclosure. The supply chain 200 includes tier-3 suppliers 203, tier-2 suppliers 202, tier-1 suppliers 202, a manufacturer 210, and a customer 220. Supplier 203-1 may manufacture part #7; supplier 203-2 may manufacture part #8, supplier 203-3 may manufacture part #9, supplier 203-4 may manufacture part #10, supplier 203-5 may manufacture part #11, supplier 203-6 may manufacture part #12, supplier 203-7 may manufacture part #13, and supplier 203-8 may manufacture part #14.

Supplier 202-1 may receive parts #7 and #8 from suppliers 203-1 and 203-2, respectively, and assemble part #3 from parts #7 and #8. Supplier 202-2 may receive parts #9 and #10 from suppliers 203-3 and 203-4, respectively, and assemble part #4 from parts #9 and #10. Supplier 202-3 may receive parts #11 and #12 from suppliers 203-5 and 203-6, respectively, and assemble part #5 from parts #11 and #12. Supplier 202-4 may receive parts #13 and #14 from suppliers 203-7 and 203-8, respectively, and assemble part #6 from parts #13 and #14. Supplier 201-1 may receive parts #3 and #4 from suppliers 202-1 and 202-2, respectively, and assemble part #1 from parts #3 and #4. Supplier 201-2 may receive parts #5 and #6 from suppliers 202-3 and 202-4, respectively, and assemble part #2 from parts #5 and #6. Manufacturer 210 may receive parts #1 and #2 from suppliers 201-1 and 201-2 respectively, and assemble those parts into a finished product. Customer 220 may purchase the finished product from manufacturer 210.

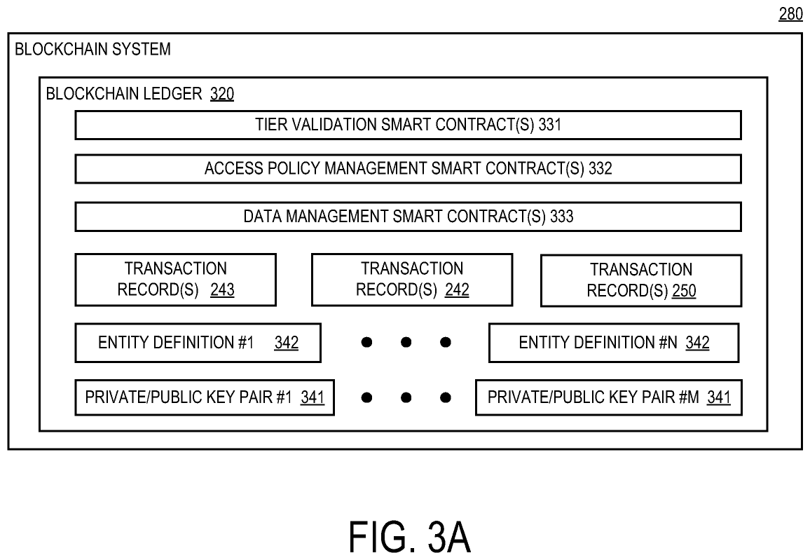

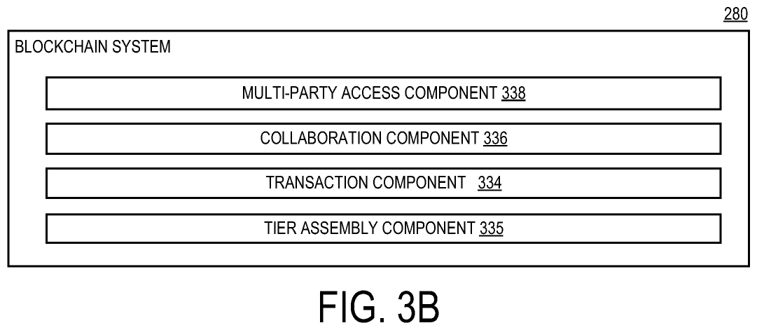

The operation of the supply chain 200 may depend on different transactions between individual suppliers in the supply chain 200. For each transaction, a respective transaction record may be stored in the ledger 320 of the blockchain system 280 (shown in FIG. 3A). Specifically, a transaction record 243-1 may be stored in the ledger 320 for the purchase of part #7 by supplier 202-1 from supplier 203-1; a transaction record 243-2 may be stored in the ledger 320 for the purchase of part #8 by supplier 202-1 from supplier 203-2; a transaction record 243-3 may be stored in the ledger 320 for the purchase of part #9 by supplier 202-2 from supplier 203-3; a transaction record 243-4 may be stored in the ledger 320 for the purchase of part #10 by supplier 202-2 from supplier 203-4; a transaction record 243-5 may be stored in the ledger 320 for the purchase of part #11 by supplier 202-3 from supplier 203-5; a transaction record 243-6 may be stored in the ledger 320 for the purchase of part #12 by supplier 202-3 from supplier 203-6; a transaction record 243-7 may be stored in the ledger 320 for the purchase of part #13 by supplier 202-4 from supplier 203-7; a transaction record 243-8 may be stored in the ledger 320 for the purchase of part #14 by supplier 202-4 from supplier 203-8; a transaction record 242-1 may be stored in the ledger 320 for the purchase of part #3 by supplier 201-1 from supplier 202-1; a transaction record 242-2 may be stored in the ledger 320 for the purchase of part #4 by supplier 201-1 from supplier 202-2; a transaction record 242-3 may be stored in the ledger 320 for the purchase of part #5 by supplier 201-2 from supplier 202-3; a transaction record 242-4 may be stored in the ledger 320 for the purchase of part #6 by supplier 201-2 from supplier 202-4; a transaction record 250-1 may be stored in the ledger 320 for the purchase of part #1 by manufacturer 210 from supplier 201-1; a transaction record 250-2 may be stored in the ledger 320 for the purchase of part #2 by manufacturer 210 from supplier 201-2; and a transaction record 250-3 may be stored in the ledger 320 for the purchase of the finished product by the customer 220. Although the supply chain 200 is depicted as including a single customer, it will be understood that, in practice, the supply chain 200 could include any number of customers.

As used throughout the disclosure, the term “tier of a supplier” refers to how far removed a supplier is from a finished product that is produced by a supply chain. For example, a tier-0 supplier may be the supplier that produces the finished product (e.g., manufacturer 210 in the example of FIG. 2). A tier-1 supplier may produce parts that are assembled into the finished product by a tier-1 supplier. A tier-2 supplier may produce parts that are assembled by tier-1 suppliers, and so forth.

By definition, any transaction in a supply chain necessarily takes place between suppliers from consecutive tiers in the supply chain (hereinafter “a purchaser” and “a seller”). Some of the information about the transaction may be desired to be shared with other suppliers in the supply chain, while other information regarding the transaction may be desired to be kept secret from everyone in the supply chain, except for the supplier and the seller. Consider a transaction between a tier-1 supplier and a tier-2 supplier of a supply. Price information associated with the transaction may be desired to be kept confidential from a tier-0 supplier of the supply chain, whereas information about any delays in executing the transaction may be desired to be shared with the tier-0 supplier. As is discussed further below, a blockchain system 280 is provided, which enables the selective sharing of information with different suppliers in a supply chain based on the respective tiers of the suppliers in the supply chain. The operation of the blockchain system 280 is discussed further below with respect to FIGS. 2B-8.

FIG. 2B is a diagram of an example of a system 270, according to aspects of the disclosure. As illustrated, the system 270 may include a plurality of computing devices 272, an authentication database 273, an external data store 274, a tier data store 275, and a blockchain system 280 that are coupled to one another via a communications network 276. The communications network 276 may include one or more of a local area network (LAN), a wide area network (WAN), a cellular network (e.g., a 5G network), the Public Switched Telephone Network (PTSN), the Internet, and/or any other suitable type of communications network.

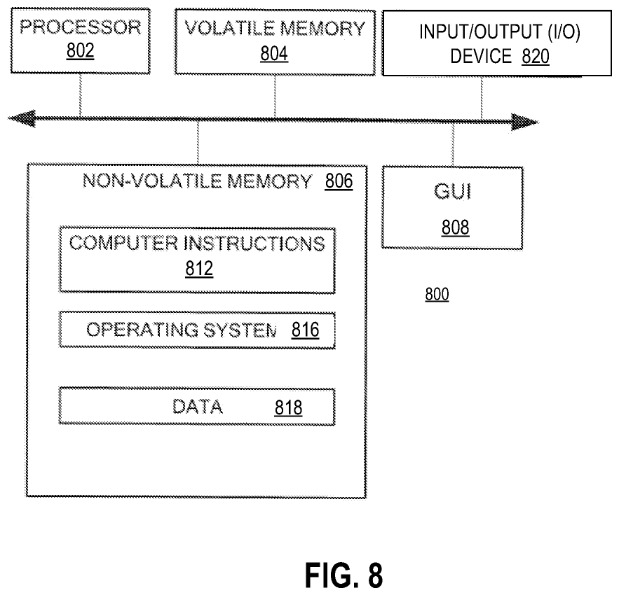

Each of the computing devices 272 may be the same or similar to the computing device 800, which is discussed further below with respect to FIG. 8. Each of the computing devices 272 may be used by a different one of the suppliers 203, 202, 201, the manufacturer 210, and the customer 220 to store and retrieve data from the blockchain system 280.

The blockchain system 280 may include any suitable type of cryptographically auditable platform that is configured to provide secure access to information associated with transactions in a supply chain. The blockchain system 280 may include any suitable type of blockchain system, such as a public blockchain, a private blockchain, or a hybrid blockchain system. According to the present example, the blockchain system 280 is implemented as a peer-to-peer network including the computing devices 272. Although in the present example the computing devices 272 are configured to operate as nodes in the blockchain system 280, alternative implementations are possible in which the computing devices 272 are external to the blockchain system 280.

The authentication database 273 may include a database for authenticating the credentials of entities that attempt to retrieve or store information in the ledger of the blockchain system 280. The external data store 274 may include one or more computing devices that are configured to store information. The tier data store 275 may include one or more computing devices that identify the topology of the supply chain 200. In some implementations, the tier data store 275 may store one or more data structures that identify all (or at least some) of the suppliers that are part of the supply chain 200, as well as the respective tiers of the suppliers. For any of the suppliers in the supply chain 200, the one or more data structures may store an identifier of the supplier and an indication of the respective tier of the supplier in the supply chain 200.

FIG. 3A is a diagram of the blockchain system 280, according to one aspect of the disclosure. Shown in FIG. 3A is a ledger 320 of the blockchain system 280. As illustrated, the ledger 320 may be configured to store the transaction records 243, 242, and 250, which are discussed above with respect to FIG. 2A. Each of the transaction records 243, 242, and 250 may be the same or similar to the transaction record 100, which is discussed above with respect to FIG. 1.

The ledger 320 may be further configured to store entity definitions 342. Each of the entity definitions 342 may correspond to a different supplier in the supply chain 200 or to a respective customer. In some implementations, for each of the suppliers in the supply chain 200, a different entity definition 342 may be provided that contains an identifier of the supplier and an indication of a tier in the supply chain 200 to which the supplier belongs. In some implementations, for any customer in the supply chain 200, a different entity definition may be provided that includes an identifier of the customer along with an indication that the entity definition belongs to a customer (rather than a supplier). Each of the entity definitions 342 may be implemented as a standalone data structure or as a portion of a larger data structure.

The ledger 320 may be further configured to store a plurality of public/private key pairs 341. Each pair 341 may correspond to a different supplier in the supply chain 200 and include a public encryption key that belongs to the supplier and a private encryption key that belongs to the supplier. The private key in each pair 341 may be one that is accessible only from within the blockchain system 280. For example, the private key in each pair 341 may be accessible only by smart contract logic that is executed by the blockchain system 280. As another example, the public key of any supplier in the supply chain 200 may be known to other suppliers in the supply chain 200, whereas the private key of any supplier in the supply chain 200 may be hidden from all other suppliers in the supply chain 200.

The ledger 320 may be further configured to store one or more smart contracts 331, one or more smart contracts 332, and one or more smart contracts 333. Each of the smart contracts 331, 332, and 333 may include logic that is executed by nodes in the blockchain system 280, by using a consensus-building mechanism of the blockchain system 280.

The smart contract(s) 331 may include logic that is configured to search (or otherwise examine) the entity definitions 342 to determine the role (e.g., the tier) in the supply chain 200 of a particular entity (e.g., a particular supplier). For example, the logic may receive as input an identifier of a supplier and return an indication of the tier of the supplier. As another example, the logic may receive as input an identifier of an entity (e.g., a customer or a supplier) and return an indication of whether the entity is a supplier or customer. As yet another example, the logic may be configured to receive a request to generate a new entity definition 342 and execute the request by creating the new entity definition 342. The request may include an identifier of a supplier and an indication of the supplier's tier in the supply chain 200. As used throughout the disclosure, the term “logic” may refer to electronic circuitry and/or one or more processor-executable instructions that cause at least one processor to perform an action when they are executed by the processor.

The smart contract(s) 332 may include logic for setting or retrieving access restriction settings for different data items in the transaction records 243, 242, and 250. For example, the logic may be configured to receive a request including (i) an identifier of a data item, (ii) an identifier of a transaction or transaction record which the data item is part of (or associated with), and (iii) an identifier of a supplier (or another entity) that is attempting to retrieve the data item. In response to the request, the logic may return an indication of whether the supplier (or other entity) is permitted to view the data item. As another example, the logic may be configured to receive a request including (i) an identifier of a data item, (ii) an identifier of a transaction or transaction record which the data item is part of (or associated with), and (iii) an identifier of a tier in the supply chain 200. In response to the request, the logic may return an indication of whether the suppliers that are part of the tier are authorized to view the data item. As another example, the logic may be configured to receive a request to grant or deny (to a supplier/entity or to a tier in the supply chain 200) permission to view a data item. In response to the request, the logic may modify the access restriction setting that is associated with the data item.

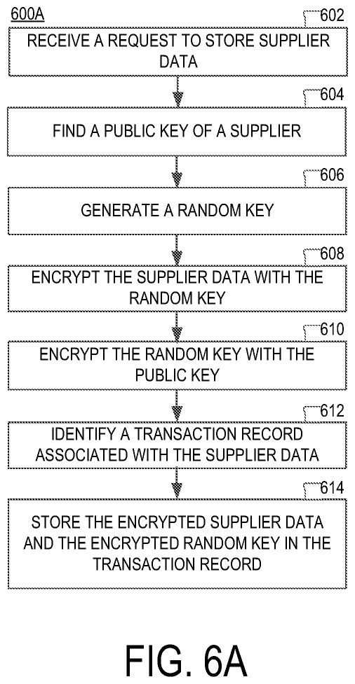

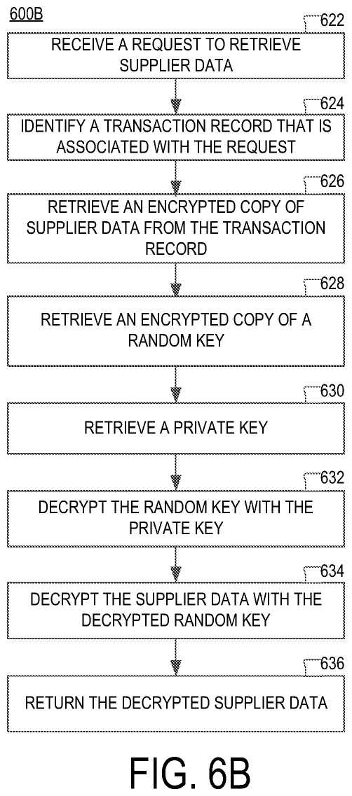

The smart contract(s) 333 may include logic for instantiating any of the transaction records 243, 242, and 250. The logic may also be configured to store or retrieve data from any of the transaction records. In some implementations, the logic may be configured to perform at least a process 600A or a process 600B, both of which are discussed further below with respect to FIGS. 6A-B.

FIG. 3A is provided as an example only. It will be understood that the present disclosure is not limited to any specific organization of the blockchain system 280. For example, any two (or more) of the data structures 243, 242, 250, 342, and 341 may be integrated into a single data structure or subdivided differently. Furthermore, any two (or more) of the smart contracts 331, 332, and 333 may be integrated into a single smart contract or subdivided differently. And still furthermore, any of the data structures 243, 242, 250, 342, and 341 (or portion thereof) may be integrated into a respective one of smart contracts 331, 332, and 333.

FIG. 3B is a high-level diagram illustrating a processing stack that is implemented by the blockchain system 280. The processing stack may include a tier assembly component 335, a transaction component 334, a collaboration component 336, and a multi-party access component 338.

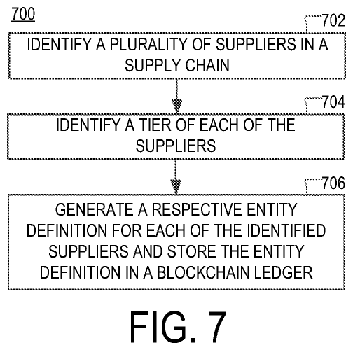

The tier assembly component 335 may be configured to generate the entity definitions 342. The tier assembly component 335 may be implemented by using smart contracts and/or other logic. The tier-assembly component 335 may include the access management smart contract(s) 332 (or portion thereof) and/or other logic. In some implementations, the tier assembly component 335 may be configured to perform a process 700, which is discussed further below with respect to FIG. 7

The transaction component 334 may be configured to generate the transaction records 243, 242, and 250. The transaction component 334 may include the data management smart contract(s) 333 (or portion thereof) and/or other logic. The transaction component 334 may specify a metadata model for the transaction records, and provide methods and routines that regulate data access rights, permission policies, and data encryption. In some implementations, the collaboration component 336 may be configured to execute processes 600A and 600B, which are discussed further below with respect to FIGS. 6A-B.

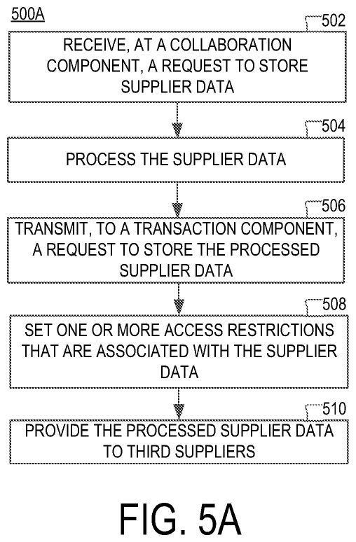

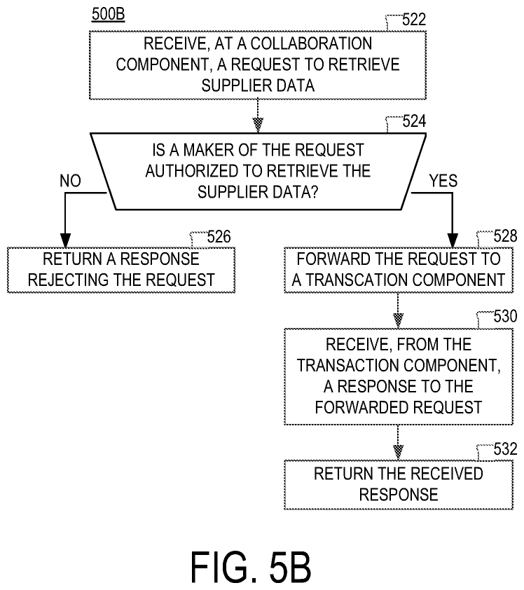

The collaboration component 336 may be configured to enforce data access policies that apply to different data items in a transaction record. The collaboration component 336 may include the access policy management smart contract(s) 332 (or portion thereof), the tier validation smart contract(s) 331 (or portion thereof), and/or other logic. The collaboration component 336 may be configured to perform processes 500A and 500B, which are discussed further below with respect to FIGS. 5A-B.

The collaboration component 336 may be configured to receive (through component 338) supplier data from different facilities and suppliers, store the supplier data in the ledger 320 along with corresponding metadata, and send the supplier data to another supplier who has gained permission from the data owner. Specifically, the collaboration component 336 may provide the following Application Programming Interfaces (APIs): (1) Submit Data, (2) Set Data Permission, and (3) Retrieve Data.

Executing the Submit Data API may cause the collaboration component 336 to interact with the transaction component 334 to generate a transaction data record for a particular transaction (if the record has not already been created), and store supplier data in the transaction record. In some implementations, the Submit Data API may process supplier data (e.g., by adding metadata to it) and call the transaction component 334 to record the processed supplier data to the ledger 320. The Submit Data API may also store an encrypted version of the supplier data to the external data store 274.

Executing the Set Data Permission API may cause the collaboration component 336 to change access restriction settings for different supplier data items. In some implementations, the Set Data Permission API may interact with the transaction component 334 to develop access restriction policies and methods.

Executing the Retrieve Data API may cause the collaboration component 336 to retrieve data from any of the transaction records 243, 242, and 250 and provide the retrieved data to the entity that invoked the Retrieve Data API. The Retrieve Data API may call smart contracts in the transaction component 334 to retrieve encrypted supplier data from the ledger 320, verify encrypted supplier data authenticity, and decrypt the encrypted data to obtain the original data. The authenticity of decrypted data may be verified by decrypting the encrypted data with a private key corresponding to the owner of the data (i.e., the supplier who stored the data in the ledger 320).

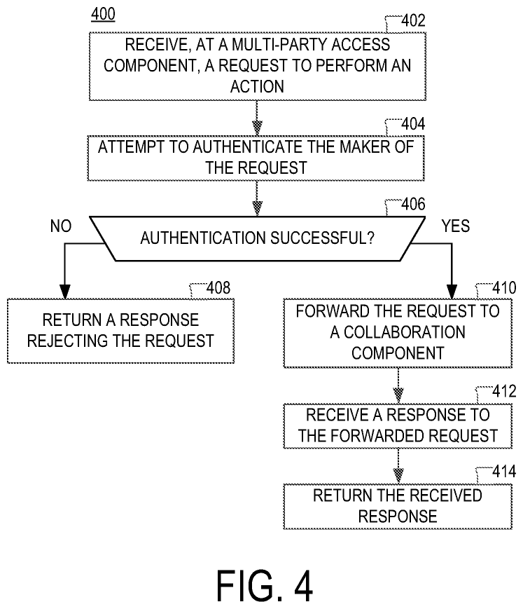

The multi-party access component 338 may provide an interface (to external clients) for accessing the services of the blockchain system 280. The component 338 may be configured the verify the identity of a supplier and cooperate with the collaboration component 336 to execute an action that is requested by the supplier (if the supplier's identity has been authenticated successfully). The multi-party access component 338 may be configured to perform a process 400, which is discussed further below with respect to FIG. 4.

FIG. 4 is a flowchart of an example of a process 400, according to aspects of the disclosure.

At step 402, the multi-party access component 338 receives a request to perform an action. The action may include storing supplier data in the ledger 320, retrieving supplier data from the ledger 320, setting access restrictions for supplier data, and or any other suitable type of action. The request may be received from one of the suppliers or customers in the supply chain 200. The request may include one or more parameters. For example, when the request is to store supplier data, the one or more parameters may include the supplier data. As another example, when the request is to set (or change) one or more access restriction settings, the one or more parameters may include the new values of the access restriction settings. As noted, the request may be received from any of the suppliers 201, 202, 203, the manufacturer 210 or the customer 220. Under the nomenclature of the present disclosure, the entity from which the request is received is also referred to as “the maker of the request.”

At step 404, the multiparty-access component attempts to authenticate the maker of the request. Authenticating the maker of the request may include authenticating credentials that are provided together with or separately from the request. The credentials may be authenticated by using the authentication database 273.

At step 406, the multi-party access component 338 determines if the authentication is successful. If the authentication is not successful, the process 400 proceeds to step 408. Otherwise, if the authentication is successful, the process 400 proceeds to step 410.

At step 408, the multiparty-access component 338 returns a response rejecting the request. The response may be returned to the maker of the request.

At step 410, the multi-party access component 338 forwards the request to the collaboration component 336. Forwarding the request to the collaboration component 336 may include providing the collaboration component 336 with one or more of (i) an indication of the action that is desired to be performed, (ii) one or more parameters of the request, and/or (iii) an indication that the supplier has been authenticated successfully.

At step 412, the multi-party access component 338 receives, from the collaboration component 336, a response to the request that is transmitted at step 410.

At step 414, the multi-party access component 338 forwards the response to the maker of the request.

FIG. 5A is a flowchart of an example of a process 500A according to aspects of the disclosure.

At step 502, the collaboration component 336 receives a request to store supplier data in the ledger 320. The request may be received from the multi-party access component 338. The request may include supplier data that is desired to be stored in the blockchain system 280. The received request may be the one that is transmitted at step 410 of the process 400.

At step 504, the collaboration component 336 processes the supplier data to produce processed supplier data. Processing the supplier data may include converting the supplier data to a standardized metadata format. For example, the supplier data (receive at step 502) may be a status update for a transaction. The status update may include the following raw supplier data: “123/expected delivery=6/6/2022.” Upon receiving the status update, the collaboration component 336 may convert the raw supplier data to the following standardized supplier data “transaction_id=123; order_shipped=true; eta=6/6/2022”. The standardized supplier data may follow a standard metadata model. The raw supplier data may follow a metadata model that is specific to the supplier which submitted the raw supplier data. Different suppliers that interact with the blockchain system 280 may use different metadata models for recording information. Converting supplier data to the standardized metadata model may ensure that all data stored in the transaction records 243, 242, and 250 has the same format.

At step 506, the collaboration component 336 transmits to the transaction component 334 a request to store the processed (e.g., standardized) supplier data (generated at step 504).

At step 508, the collaboration component 336 sets one or more access restrictions for the supplier data. For any (or each) data item in the processed supplier data (generated at step 504), the collaboration component 336 may set the value of a respective access restriction setting. The value may be set by executing the access policy management smart contract(s) 332.

At step 510, the collaboration component 336 may provide portions of the processed supplier data to third suppliers. The supplier data may be data associated with a specific transaction between a first supplier and a second supplier (e.g., a purchaser and a seller, etc.). Both the first supplier and the second supplier may be part of the supply chain 200. A third supplier is another supplier in the supply chain 200 that is neither the first supplier nor the second supplier. The third supplier may or may not be from a different tier of the supplier chain 200 than the first supplier and/or the second supplier. Specifically, at step 510, for each (or any) data item in the processed supplier data, the collaboration component 336 may (i) identify an access restriction setting for the data item, (ii) identify one or more suppliers that are permitted to view the data item based on the access restriction setting, and (iii) instruct the multi-party access component 338 to provide the data item to the suppliers which are permitted to view the data item. In instances in which the access restriction setting for a data item indicates that an entire tier in the supply chain 200 is permitted to view the data item, the data item may be disseminated by the collaboration component 336 to all suppliers in the tier. For example, the collaboration component 336 may instruct the multi-party access component 338 to provide the data item to all of the suppliers in the tier.

FIG. 5B is a flowchart of an example of a process 500B, according to aspects of the disclosure. At step 522, the collaboration component 336 receives a request to retrieve supplier data from the ledger 320. The request may be received from the multi-party access component 338. The request may be the one that is transmitted at step 410 of the process 400. The request may identify one or more of: (i) a transaction or a transaction record corresponding to the transaction, and (ii) a specific data item that is desired to be retrieved from the transaction record corresponding to the transaction. At step 524, the collaboration component 336 determines if the maker of the request is authorized to retrieve the supplier data from the ledger 320. The determination can be made by executing the access policy management smart contract(s) 332 and/or by executing the tier validation smart contract(s) 331. If the maker of the request is not authorized to retrieve the requested supplier data item, the process 500B proceeds to step 526. Otherwise, if the maker of the request is authorized to retrieve the requested supplier data item, the process 500B proceeds to step 528. At step 526, the collaboration component 336 returns a response rejecting the request. The response is returned to the multi-party access component 338. At step 528, the collaboration component 336 forwards the request to the transaction component 334. At step 530, the collaboration component 336 receives a response to the request from the transaction component 334. The response may include the requested supplier data item or an indication that the supplier data cannot be obtained. At step 532, the collaboration component 336 returns the received response to the multi-party access component 338.

In some implementations, at step 524, the collaboration component 336 may execute the smart contract(s) 331 to determine the tier in the supply chain 200 of the maker of the request (e.g., a supplier from which the initial request is received at step 402). Afterwards, the collaboration component 336 may execute the smart contract(s) 332 to determine if the tier of the maker of the request is authorized to view the data item that is requested. For example, the collaboration component 336 may submit to the smart contract(s) 332 an indication of the tier of the maker of the request (as well as an identifier of the requested data item and a corresponding transaction/transaction record). In response, the collaboration component 336 may receive a response indicating whether all members of the tier are authorized to view the requested data item. If the requested data item is made available to all members of the tier of the maker of the request, the collaboration component 336 may determine that the maker of the request is authorized to retrieve the data item. Otherwise, the collaboration component 336 may determine that the maker of the request is not authorized to obtain the data item. In some respects, executing the smart contract 331 allows the collaboration component 336 to use a consensus-building mechanism of the blockchain system 280 to verify the tier of the maker of the request. In some respects, executing the smart contract 332 allows the collaboration component 336 to use a consensus-building mechanism of the blockchain system 280 to verify the access permissions for the data item. The terms “access permission”, “access restriction”, and “access policy” are used interchangeably throughout the disclosure.

FIG. 6A is a flowchart of an example of a process 600A, according to aspects of the disclosure. At step 602, the transaction component 334 receives a request to store supplier data in the blockchain system 280. The supplier data may be the same or similar to the processed supplier data that is generated at step 504 of the process 500A. The supplier data may include one or more supplier data items. The request may be retrieved from the collaboration component 336. The request may be the one that is transmitted at step 506 of the process 500A. According to the present example, the maker of the request is one of the suppliers in the supply chain 200. At step 604, the transaction component identifies the public key that is associated with the supplier making the request. The public key may be part of one of the key pairs 341 that is associated with the supplier making the request. In some implementations, the supplier data may be associated with a transaction, and the supplier making the request may be either the purchaser or the seller in the transaction. At step 606, the transaction component 334 generates a random encryption key. At step 608, the transaction component 334 encrypts the supplier data with the random encryption key. At step 610, the transaction component 334 encrypts the random encryption key with the public key (identified at step 604). At step 612, the transaction component 334 identifies a transaction record that is associated with the supplier data. Identifying the transaction record may include obtaining a transaction ID that is received with the request to store the supplier data and performing a search of the ledger 320 to identify a transaction record that is associated with the transaction. If no transaction record is available, the transaction component 334 may instantiate (in the ledger 320) a new transaction record that is associated with the transaction. At step 614, the transaction component 334 stores the encrypted random key and the encrypted supplier data in the transaction record that is identified or created at step 612.

FIG. 6B is a flowchart of an example of a process 600B, according to aspects of the disclosure. At step 622, the transaction component 334 receives a request to retrieve supplier data from the blockchain ledger 320. The request may be received from the collaboration component 336. The request may be the one that is transmitted at step 528 of the process 500B. In some implementations, the request may include at least one of: (i) a transaction or a transaction record corresponding to the transaction, and (ii) a data item (or multiple data items) that are desired to be retrieved from the identified transaction record. At step 624, the transaction component 334 identifies a transaction record that is associated with the request. As noted above, the transaction record may be identified based on information contained in the request. At step 626, the transaction component 334 retrieves an encrypted copy of supplier data from the record (identified at step 626). At step 628, the transaction component 334 retrieves, from the transaction record (identified at step 624), an encrypted copy of a random key that can be used to decrypt the supplier data. At step 630, the transaction component 334 retrieves a private key that corresponds to the public key used to encrypt the random key. The private key may be part of the same pair 341 as the public key. At step 632, the transaction component 334 decrypts the random key with the private key. At step 634, the transaction component 334 decrypts the supplier data with the decrypted random key. At step 636, the transaction component 334 returns the decrypted supplier data. In some implementations, the transaction component may extract from the decrypted supplier data the supplier data items that are requested and return only those supplier data items.

FIG. 7 is flowchart of an example of a process 700, according to aspects of the disclosure. At step 702, the tier assembly component 335 identifies the suppliers that are part of the supply chain 200. Identifying the suppliers may include retrieving a respective identifier of each of the suppliers from the tier data store 275. At step 704, the tier assembly component 335 identifies the respective tier in the supply chain 200 of each of the suppliers (identified at step 702). Identifying the respective tier of each of the suppliers may include retrieving an identifier of the respective tier from the tier data store 275. At step 706, the tier assembly component 335 generates a respective entity definition 342 for each of the identified suppliers and stores the generated entity definition in the ledger 320. Generating the entity definition for any of the suppliers may include instantiating the definition, inserting an identifier of the supplier in the instantiated definition, and inserting an identifier of the tier of the supplier, in the supply chain 200, in the instantiated definition. Although in the example of FIG. 7 the process 700 generates entity definitions for suppliers only, alternative implementations are possible in which the process 700 generates entity definitions for both suppliers and customers.

Referring to FIG. 8, computing device 800 may include processor 802, volatile memory 804 (e.g., RAM), non-volatile memory 806 (e.g., a hard disk drive, a solid-state drive such as a flash drive, a hybrid magnetic and solid-state drive, etc.), graphical user interface (GUI) 808 (e.g., a touchscreen, a display, and so forth) and input/output (I/O) device 820 (e.g., a mouse, a keyboard, etc.). Non-volatile memory 806 stores computer instructions 812, an operating system 816 and data 818 such that, for example, the computer instructions 812 are executed by the processor 802 out of volatile memory 804. Program code may be applied to data entered using an input device of GUI 808 or received from I/O device 820.

Processor 802 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard-coded into the electronic circuit or soft coded by way of instructions held in a memory device. A “processor” may perform the function, operation, or sequence of operations using digital values or using analog signals. In some embodiments, the “processor” can be embodied in an application-specific integrated circuit (ASIC). In some embodiments, the “processor” may be embodied in a microprocessor with associated program memory. In some embodiments, the “processor” may be embodied in a discrete electronic circuit. The “processor” may be analog, digital or mixed-signal. In some embodiments, the “processor” may be one or more physical processors or one or more “virtual” (e.g., remotely located or “cloud”) processors.

The term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and
storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs,
wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

2. The method of claim 1, wherein the block chain system is configured to store one or more data structures that identify a respective tier of each of a plurality of suppliers in a supply chain.

3. The method of claim 1, wherein generating a response to the request includes identifying a tier of the third supplier by using a consensus-building mechanism that is provided by the blockchain system, and evaluating, based on the identified tier, an access policy that controls access to the given data item.

4. The method of claim 1, wherein the blockchain system is further configured to:
receive a request to store the given data item;
identify a public encryption key that belongs to at least one of the first supplier and the second supplier;
generate an encryption key;
encrypt the given data item with the generated encryption key to produce an encrypted instance of the given data item;
encrypt the generated encryption key with the public encryption key to produce an encrypted instance of the generated encryption key; and
store the encrypted instance of the generated encryption key and the encrypted instance of the given data item in a ledger of the blockchain system.

5. The method of claim 1, wherein generating the response includes:
retrieving an encrypted instance of the given data item that is encrypted, at least in part, by using a public key that belong to one of the first supplier and the second supplier;
decrypting the encrypted instance of the given data item to produce a decrypted instance of the given data item, the decrypting being performed by using a private key that is associated with the public key, the private key being accessible only from within the blockchain system; and
returning the decrypted instance of the given data item.

6. The method of claim 1, wherein the first supplier, the second supplier, and the third supplier are different suppliers.

7. The method of claim 1, wherein the tier of the third supplier indicates how far removed is the third supplier from a finished product that is produced by the supply chain.

8. The method of claim 1, wherein the logic is part of a smart contract.

9. A system, comprising:
one or more processors configured to perform the operations of:
storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and
storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs,
wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

10. The system of claim 9, wherein the block chain system is configured to store one or more data structures that identify a respective tier of each of a plurality of suppliers in a supply chain.

11. The system of claim 9, wherein generating a response to the request includes identifying a tier of the third supplier by using a consensus-building mechanism that is provided by the blockchain system, and evaluating, based on the identified tier, an access policy that controls access to the given data item.

12. The system of claim 9, wherein the blockchain system is further configured to:
receive a request to store the given data item;
identify a public encryption key that belongs to at least one of the first supplier and the second supplier;
generate an encryption key;
encrypt the given data item with the generated encryption key to produce an encrypted instance of the given data item;
encrypt the generated encryption key with the public encryption key to produce an encrypted instance of the generated encryption key; and
store the encrypted instance of the generated encryption key and the encrypted instance of the given data item in a ledger of the blockchain system.

13. The system of claim 9, wherein generating the response includes:
retrieving an encrypted instance of the given data item that is encrypted, at least in part, by using a public key that belong to one of the first supplier and the second supplier;
decrypting the encrypted instance of the given data item to produce a decrypted instance of the given data item, the decrypting being performed by using a private key that is associated with the public key, the private key being accessible only from within the blockchain system; and
returning the decrypted instance of the given data item.

14. The system of claim 9, wherein the first supplier, the second supplier, and the third supplier are different suppliers.

15. The system of claim 9, wherein the tier of the third supplier indicates how far removed is the third supplier from a finished product that is produced by the supply chain.

16. The system of claim 9, wherein the logic is part of a smart contract.

17. A non-transitory computer-readable medium storing one or more processor-executable instructions which, when executed, by one or more processors cause the one or more processors to perform the operations of:
storing, in a ledger of a blockchain system, a transaction record containing information associated with a first purchase that is made in a supply chain, the supply chain including a plurality of suppliers, the first purchase being made by a first one of the plurality of suppliers from a second one of the plurality of suppliers, the transaction record containing a plurality of data items associated with the first purchase; and
storing, in the ledger of the blockchain system, a logic for enforcing one or more data access policies, the logic being configured to control access to at least one of the plurality of data items in the transaction record by any given one of the plurality of suppliers based on a respective tier in the supply chain to which the given supplier belongs,
wherein the blockchain system is configured to: (i) receive, from a third one of the plurality of suppliers, a request for any given one of the plurality of data items and (ii) generate a response to the request based on a tier in the supply chain of the third supplier, the response being generated, at least in part, by executing the logic.

18. The non-transitory computer-readable medium of claim 17, wherein the block chain system is configured to store one or more data structures that identify a respective tier of each of a plurality of suppliers in a supply chain.

19. The non-transitory computer-readable medium of claim 17, wherein generating a response to the request includes identifying a tier of the third supplier by using a consensus-building mechanism that is provided by the blockchain system, and evaluating, based on the identified tier, an access policy that controls access to the given data item.

20. The non-transitory computer-readable medium of claim 17, wherein the tier of the third supplier indicates how far removed is the third supplier from a finished product that is produced by the supply chain.
